(19) United States
(12) Patent Application Publication
(10) Pub. No.: US 2019/0097228 A1
(43) Pub. Date: Mar. 28, 2019

(54) NONAQUEOUS ELECTROLYTE SECONDARY BATTERY

(71) Applicant: SANYO Electric Co., Ltd., Daito-shi, Osaka (JP)

(72) Inventor: Kei Kobayashi, Osaka (JP)

(73) Assignee: SANYO Electric Co., Ltd., Daito-shi, Osaka (JP)

(21) Appl. No.: 16/086,450

(22) PCT Filed: Mar. 10, 2017
(86) PCT No.: PCT/JP2017/009697

§ 371 Date: Sep. 19, 2018

(30) Foreign Application Priority Data
Mar. 24, 2016 (JP) 2016-060161

(51) Int. Cl. H01M 4/56; H01M 10/0587; H01M 4/75; H01M 2/34

(52) U.S. Cl. CPC H01M 4/56; H01M 10/0587; H01M 2004/027; H01M 2/34; H01M 4/75

(57) ABSTRACT

A nonaqueous electrolyte secondary battery according to one example of an embodiment includes: a wound electrode assembly in which a positive electrode and a negative electrode are wound with at least one separator interposed therebetween. In the nonaqueous electrolyte secondary battery, a negative electrode lead is bonded to an inner surface X of a negative electrode collector facing the inside in a radial direction, and an insulating tape is adhered to, among surfaces of an overlapping portion of the negative electrode lead and the negative electrode collector, at least a surface at an outer side in the radial direction of the electrode assembly. The insulating tape includes a base material layer, an adhesive layer, and an inorganic particle-containing layer formed therebetween, and the inorganic particle-containing layer contains 20 percent by weight or more of inorganic particles with respect to the weight of the layer described above.

### TECHNICAL FIELD

The present disclosure relates to a nonaqueous electrolyte secondary battery.

### BACKGROUND ART

Patent Document 1 has disclosed an insulating tape to be used for a nonaqueous electrolyte secondary battery, the insulating tape including an adhesive layer and an inorganic particle-containing layer which contains inorganic particles. In addition, Patent Document 1 has also disclosed a usage mode in which the insulating tape described above is adhered to a lead which is used for electrical connection between a terminal and a collector of an electrode.

### CITATION LIST

### Patent Literature

Patent Document 1: Japanese Published Unexamined Patent Application No. 2006-93147

### SUMMARY OF INVENTION

### Technical Problem

Incidentally, although a lead is bonded to an electrode plate forming a wound electrode assembly, for example, when an electrically conductive foreign material intrudes into a portion at which a negative electrode lead and a positive electrode are overlapped with each other in a radial direction of the electrode assembly, the foreign material may break through a separator, and an internal short circuit may be generated in some cases. Since the lead has a thickness larger than that of the electrode plate, the pressure between the electrode plates at a portion to which the lead is connected is liable to be increased, and as a result, the internal short circuit is liable to be generated as compared to that at the other portion. Since the pressure between the electrode plates tends to be increased at a winding core side of the electrode assembly, when the negative electrode lead is fitted to a winding-start side end portion of the negative electrode, the internal short circuit is more liable to be generated.

In addition, in a nonaqueous electrolyte secondary battery, when the internal short circuit is generated, prevention of expansion of a short-circuit portion and suppression of increase in battery temperature are also important subjects.

### Solution to Problem

A nonaqueous electrolyte secondary battery according to one aspect of the present disclosure comprises: a wound electrode assembly in which a positive electrode and a negative electrode are wound with at least one separator interposed therebetween; the negative electrode includes a belt-shaped negative electrode collector and a negative electrode lead bonded to a winding-start side end portion of the negative electrode collector; an insulating tape is adhered to, among surfaces of an overlapping portion between the negative electrode lead and the negative electrode collector, at least a surface at an outer side in a radial direction of the electrode assembly; the insulating tape includes a base material layer, an adhesive layer, and an inorganic particle-containing layer formed therebetween; and the inorganic particle-containing layer contains 20 percent by weight or more of inorganic particles with respect to the weight of the layer described above.

### Advantageous Effects of Invention

According to the nonaqueous electrolyte secondary battery of the present disclosure, an internal short circuit to be generated by an electrically conductive foreign material which intrudes into a portion at which the negative electrode lead bonded to the winding-start side end portion of the negative electrode and the positive electrode are overlapped with each other in the radial direction of the electrode assembly can be highly suppressed. In addition, even if the internal short circuit as described above is generated, the expansion of the short-circuit portion can be prevented, and the increase in battery temperature can also be suppressed.

### BRIEF DESCRIPTION OF DRAWINGS

FIG. 1 is a cross-sectional view of a nonaqueous electrolyte secondary battery according to one example of an embodiment.

FIG. 2 is a perspective view of a wound electrode assembly according to one example of the embodiment.

FIG. 3 is a front view of a positive electrode and a negative electrode which collectively form the electrode assembly according to one example of the embodiment.

FIG. 4 is a radial direction cross-sectional view of the vicinity of a winding core of the electrode assembly according to one example of the embodiment.

FIG. 5 is an axial-direction cross-sectional view of the vicinity of the winding core of the electrode assembly according to one example of the embodiment.

FIG. 6 is an axial-direction cross-sectional view of the vicinity of a winding core of an electrode assembly according to another example of the embodiment.

FIG. 7 is a cross-sectional view of an insulating tape according to one example of the embodiment.

### DESCRIPTION OF EMBODIMENTS

As described above, when an electrically conductive foreign material intrudes into a portion at which the negative electrode lead and the positive electrode are overlapped with each other in a radial direction of the electrode assembly, the foreign material may break through the separator, and an internal short circuit may be generated in some cases. In addition, when the internal short circuit is generated, the temperature is increased at a short-circuit portion, and by the heat thus generated, the separator may be melted so as to expand the short-circuit portion in some cases. In order to overcome the problems described above, for example, adhesion of the insulating tape disclosed in Patent Document 1 to the surface of the negative electrode lead or the winding-start side end portion of the collector to which the negative electrode lead is bonded may be considered. However, although a tape including an inorganic particle-containing layer and an adhesive layer, such as the tape disclosed in Patent Document 1, can improve a heat resistance by increasing the addition amount of inorganic particles, when the addition amount thereof is increased, a piercing strength is decreased, so that a trade-off relationship exists.

In order to prevent the generation of the above internal short circuit, the insulating tape is required to have a high piercing strength so that even if an electrically conductive foreign material breaks through the separator, the contact between the negative electrode and the positive electrode is prevented by the insulating tape. On the other hand, when the internal short circuit is generated by application of a large force, the insulating tape is required to have a high heat resistance so that even when the separator is melted by the heat generated at the short-circuit portion, the contact between the negative electrode and the positive electrode is prevented by the insulating tape. By the tape disclosed in Patent Document 1, since the heat resistance and the piercing strength cannot be simultaneously achieved as described above, the problems described above cannot be overcome.

Through intensive research carried out by the present inventors to solve the above problems, a new electrode assembly which uses an insulating tape including at least three layers, that is, a base material layer/an inorganic particle-containing layer containing 20 percent by weight or more of inorganic particles/an adhesive layer was found. The insulating tape having a three-layer structure as described above is excellent in heat resistance and also has a high piercing strength. When the insulating tape as described above is adhered to the surface of the negative electrode lead or the winding-start side end portion of the collector to which the negative electrode lead is bonded, the generation of the above internal short circuit can be highly suppressed, and even when the short circuit is generated by application of a large force, the expansion of the short-circuit portion can be suppressed, and the increase in temperature of the battery can also be suppressed.

Heretofore, although the negative electrode lead was generally fitted to a winding-finish side end portion of the negative electrode, as the capacity and the output of the battery are increased, a proposal in that two negative electrode leads are fitted to the winding-start side end portion and the winding-finish side end portion of the negative electrode has been made. Accordingly, the measures against the above internal short circuit become more important. In addition, in the case in which a space is formed in a winding core of the electrode assembly, the winding-start side end portion of the negative electrode may be unfavorably bent into the space, for example, by the expansion of an active material. In the case described above, when the corner of the negative electrode lead is strongly brought into contact with the separator so as to break through the separator, the internal short circuit may be generated in some cases; however, this problem may also be overcome by using the above insulating tape.

Hereinafter, one example of an embodiment will be described in detail.

The drawings to be used for illustrating the embodiment are schematically drawn, and hence, particular dimensional ratios and the like are to be understood in consideration of the following description. In this specification, when the term “approximately” is explained using approximately the same by way of example, the “approximately the same” is intentionally used to include not only “completely the same” but also “substantially the same”. In addition, the term “end portion” indicates the end of an object and the vicinity thereof, and the term “central portion” indicates the center of an object and the vicinity thereof.

Although a nonaqueous electrolyte secondary battery 10 which is a cylindrical battery including a cylindrical metal-made case will be described as one example of the embodiment, a nonaqueous electrolyte secondary battery of the present disclosure is not limited thereto. The nonaqueous electrolyte secondary battery of the present disclosure may be, for example, either a prismatic battery including a prismatic metal-made case or a laminate battery including an exterior package body formed of resin-made sheets.

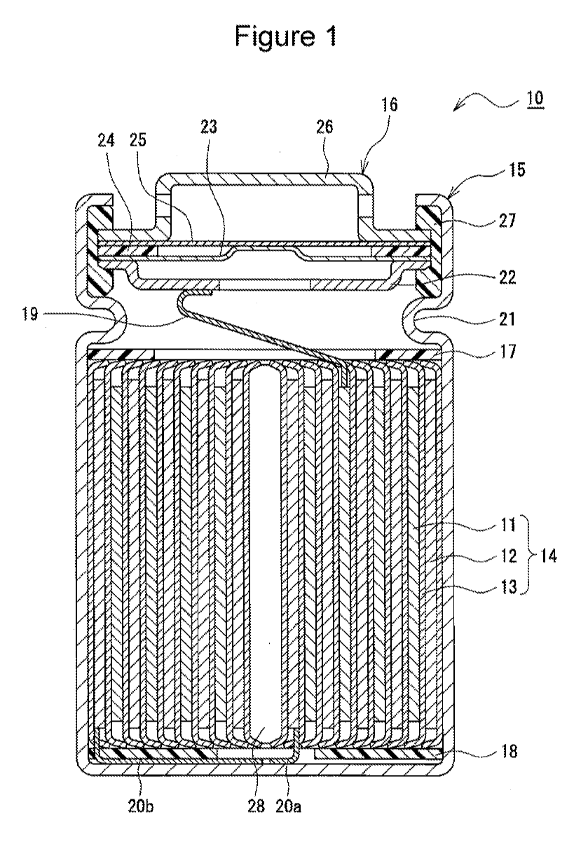

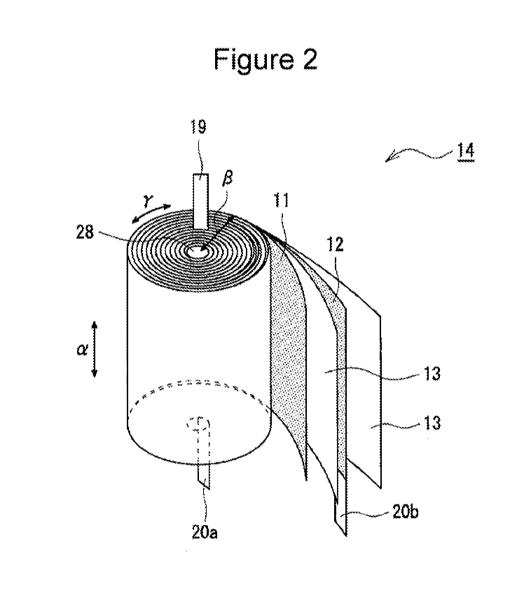

FIG. 1 is a cross-sectional view of the nonaqueous electrolyte secondary battery 10. FIG. 2 is a perspective view of an electrode assembly 14 forming the nonaqueous electrolyte secondary battery 10. As illustrated in FIGS. 1 and 2, the nonaqueous electrolyte secondary battery 10 includes the wound electrode assembly 14 and a nonaqueous electrolyte (not shown). The wound electrode assembly 14 includes a positive electrode 11, a negative electrode 12, and at least one separator 13, and the positive electrode 11 and the negative electrode 12 are spirally wound with the separator 13 interposed therebetween. Hereinafter, one axial direction of the electrode assembly 14 is called “upper side”, and the other axial direction is called “lower side” in some cases. The nonaqueous electrolyte includes a nonaqueous solvent and an electrolyte salt dissolved in the nonaqueous solvent. The nonaqueous electrolyte is not limited to a liquid electrolyte and may also be a solid electrolyte using a gel polymer or the like.

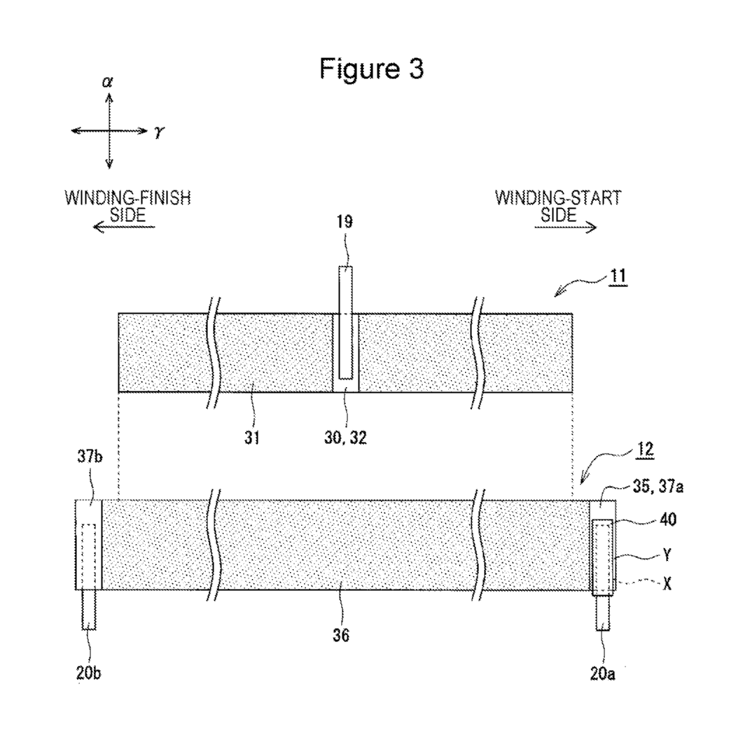

The positive electrode 11 includes a belt-shaped positive electrode collector 30 (see FIG. 3 which will be described below) and a positive electrode lead 19 bonded to the above collector. The positive electrode lead 19 is an electrically conductive member electrically connecting the positive electrode collector 30 and a positive electrode terminal and extends past an upper end of an electrode group in an axial direction α (upper side) of the electrode assembly 14. In this case, the electrode group indicates the electrode assembly 14 other than the leads. The positive electrode lead 19 is provided at an approximately central portion of the electrode assembly 14 in a radial direction β thereof.

The negative electrode 12 includes a belt-shaped negative electrode collector 35 (see FIG. 3 which will be described below) and negative electrode leads 20a and 20b connected to the above collector. The negative electrode leads 20a and 20b are electrically conductive members electrically connecting the negative electrode collector 35 and a negative electrode terminal and extend past a lower end of the electrode group in the axial α (lower side). For example, the negative electrode lead 20a is provided at a winding-start side end portion disposed at an inner end portion of the electrode assembly 14 in the radial direction, and the negative electrode lead 20b is provided at a winding-finish side end portion disposed at an outer end portion of the electrode assembly 14 in the radial direction. Hereinafter, the inside of the electrode assembly 14 in the radial direction is called a winding core side, and the outside of the electrode assembly 14 in the radial direction is called a winding outer side in some cases.

The positive electrode lead 19 and the negative electrode leads 20a and 20b are each a belt-shaped electrically conductive member having a thickness larger than that of the collector. The thickness of the lead is, for example, 3 to 30 times the thickness of the collector and is generally 50 to 500 μm. Although a constituent material of each lead is not particularly limited, the positive electrode lead 19 is preferably formed from a metal containing aluminum as a primary component, and the negative electrode leads 20a and 20b are each preferably formed from a metal containing nickel or copper as a primary component. In addition, the number of the leads, the arrangement thereof, and the like are not particularly limited. For example, the negative electrode lead may be fitted only to the winding-start side end portion of the negative electrode 12.

In the example shown in FIG. 1, a metal-made battery case receiving the electrode assembly 14 and the nonaqueous electrolyte is formed by a case main body 15 and a sealing body 16. Insulating plates 17 and 18 are provided at an upper side and a lower side of the electrode assembly 14, respectively. The positive electrode lead 19 extends to a sealing body 16 side through a through-hole of the insulating plate 17 and is welded to a bottom surface of a filter 22 which is a bottom plate of the sealing body 16. In the nonaqueous electrolyte secondary battery 10, a cap 26 which is a top plate of the sealing body 16 electrically connected to the filter 22 is used as the positive electrode terminal. On the other hand, the negative electrode lead 20a which passes through a through-hole of the insulating plate 18 and the negative electrode lead 20b which passes along the outside of the insulating plate 18 each extend to a bottom portion side of the case main body 15 and are then welded to an inner surface of the bottom portion of the case main body 15. In the nonaqueous electrolyte secondary battery 10, the case main body 15 functions as the negative electrode terminal.

As described above, the electrode assembly 14 has a winding structure in which the positive electrode 11 and the negative electrode 12 are spirally wound with the separator 13 interposed therebetween. The positive electrode 11, the negative electrode 12, and the separator 13 are each formed to have a belt shape and are spirally wound so as to be alternately laminated to each other in the radial direction β of the electrode assembly 14. In the electrode assembly 14, the longitudinal direction of each electrode is a winding direction γ, and the width direction of each electrode is the axial direction α. In this embodiment, a space 28 is formed in a winding core of the electrode assembly 14. Although the details will be described later, the electrode assembly 14 includes an insulating tape 40 (see FIG. 3 or the like) which is adhered to the winding-start side end portion of the negative electrode 12.

The case main body 15 is a cylindrical metal-made container having a bottom plate. A gasket 27 is provided between the case main body 15 and the sealing body 16 so that air tightness in the battery case is secured. The case main body 15 has a protruding portion 21 which is formed, for example, by pressing a side surface portion from the outside and which supports the sealing body 16. The protruding portion 21 is preferably formed to have an annular shape along a circumference direction of the case main body 15, and an upper surface of the protruding portion 21 supports the sealing body 16.

The sealing body 16 includes the filter 22, a lower valve body 23, an insulating member 24, an upper valve body 25, and the cap 26 laminated in this order from an electrode assembly 14 side. The individual members forming the sealing body 16 each have, for example, a circular plate shape or a ring shape, and the members other than the insulating member 24 are electrically connected to each other. The lower valve body 23 and the upper valve body 25 are connected to each other at the central portions thereof, and between the peripheral portions of the valve bodies, the insulating member 24 is provided. When the inside pressure of the battery is increased by abnormal heat generation, for example, since the lower valve body 23 is fractured, the upper valve body 25 is expanded to a cap 26 side and is separated from the lower valve body 23, so that the electrical connection between the valve bodies is disconnected. When the inside pressure is further increased, the upper valve body 25 is fractured, and a gas is exhausted from an opening portion of the cap 26.

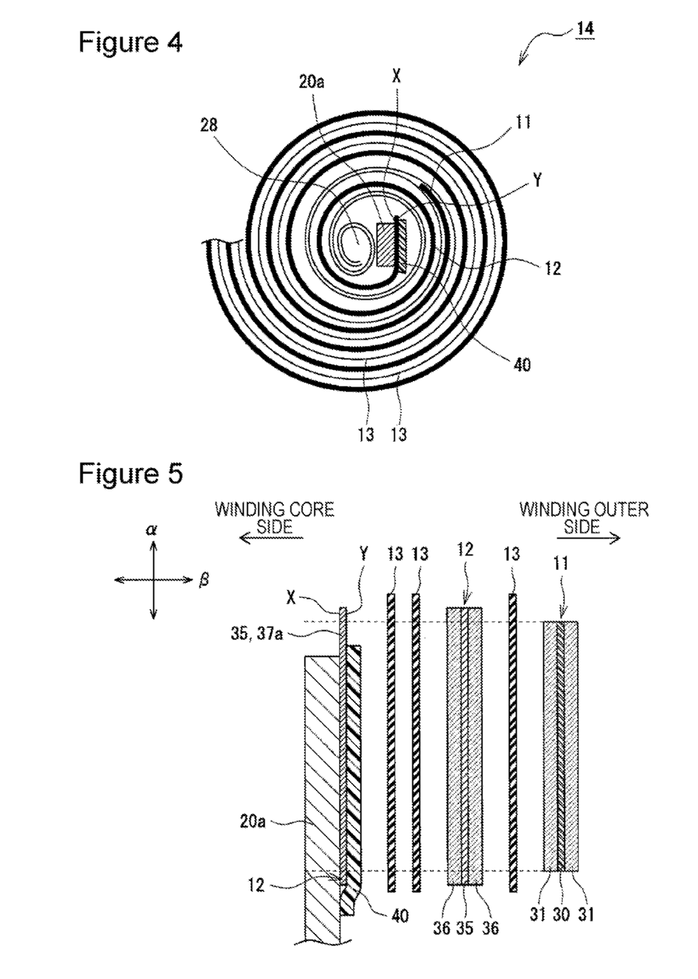

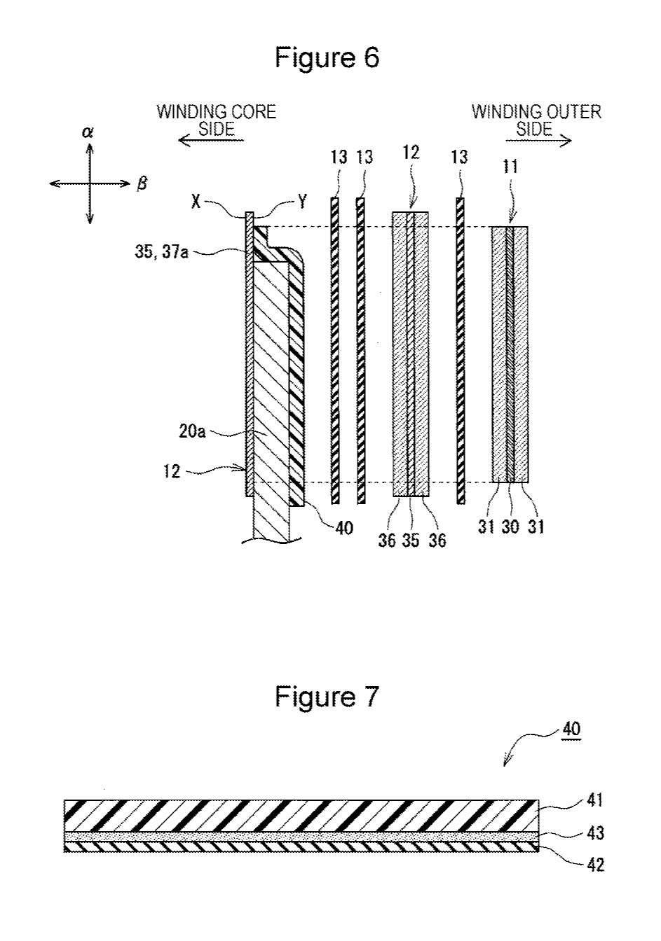

Hereinafter, with reference to FIGS. 3 to 6, the electrode assembly 14, in particular, the insulating tape 40 to be adhered to the negative electrode 12 and the negative electrode lead 20a, will be described in detail. FIG. 3 is a front view of the positive electrode 11 and the negative electrode 12 which collectively form the electrode assembly 14. In FIG. 3, the state in which the electrodes are each linearly extended is shown, and the right side on the plane is the winding-start side of the electrode assembly 14, and the left side on the plane is the winding-finish side of the electrode assembly 14. FIG. 4 is a cross-sectional view of the vicinity of the winding core of the electrode assembly 14 taken along the radial direction β. FIGS. 5 and 6 are each a cross-sectional view of the vicinity of the winding core of the electrode assembly 14 taken along the axial direction α.

As illustrated in FIGS. 3 and 4, in the electrode assembly 14, in order to prevent precipitation of lithium on the negative electrode 12, the negative electrode 12 is formed to have a size larger than that of the positive electrode 11. In addition, a portion at which a positive electrode active material layer 31 of the positive electrode 11 is formed is at least disposed to face a portion at which a negative electrode active material layer 36 of the negative electrode 12 is formed with the separator 13 interposed therebetween. The width and the length of the negative electrode collector 35 determining the size of the negative electrode 12 are set so as to be larger than the width and the length of the positive electrode collector 30 determining the size of the positive electrode 11.

The positive electrode 11 includes the belt-shaped positive electrode collector 30 and at least one positive electrode active material layer 31 formed on the above collector. In this embodiment, the positive electrode active material layers 31 are formed on two surfaces of the positive electrode collector 30. As the positive electrode collector 30, foil of a metal, such as aluminum, a film having a surface layer on which the metal mentioned above is disposed, or the like is used. A preferable positive electrode collector 30 is foil of a metal containing aluminum or an aluminum alloy as a primary component. The thickness of the positive electrode collector 30 is, for example, 10 to 30 μm.

The positive electrode active material layer 31 is preferably formed over the entire region of each of the two surfaces of the positive electrode collector 30 other than at least one plain portion 32 which will be described later. The positive electrode active material layer 31 preferably contains a positive electrode active material, an electrically conductive agent, and a binding agent. The positive electrode 11 (positive electrode plate) may be formed in such a way that after a positive electrode mixture slurry containing the positive electrode active material, the electrically conductive agent, the binding agent, and a solvent, such as N-metnyl-2-pyrrolidone (NMP), is applied on the two surfaces of the positive electrode collector 30, the coating films thus formed are then compressed.

As the positive electrode active material, a lithium transition metal oxide containing a transition metal element, such as Co, Mn, or Ni, may be mentioned by way of example. Although the lithium transition metal oxide is not particularly limited, a composite oxide represented by the general formula Li₁₊ₓMO₂ (in the formula, −0.2<x≤0.2 holds, and M represents at least one of Ni, Co, Mn, and Al) is preferable.

As an example of the electrically conductive agent, a carbon material, such as carbon black (CB), acetylene black (AB), Ketjen black, graphite, or the like may be mentioned. As an example of the binding agent, a fluorine-based resin, such as a polytetrafluoroethylene (PTFE) or a poly(vinylidene fluoride) (PVdF), a polyacrylonitrile (PAN), a polyimide (PI), an acrylic-based resin, a polyolefin-based resin, or the like may be mentioned. In addition, those resins each may be used together with a carboxymethyl cellulose (CMC) or its salt, a poly(ethylene oxide) (PEO), or the like. Those resins may be used alone, or at least two types thereof may be used in combination.

The positive electrode 11 has the plain portion 32 at which a surface of a metal forming the positive electrode collector 30 is exposed. The plain portion 32 is a portion to which the positive electrode lead 19 is connected and is a portion at which the surface of the positive electrode collector 30 is not covered with the positive electrode active material layer 31. The plain portion 32 is formed to have a width larger than that of the positive electrode lead 19. The plain portions 32 are preferably provided on two surfaces of the positive electrode 11 so as to be overlapped with each other in a thickness direction of the positive electrode 11.

In the example shown in FIG. 3, at the central portion of the positive electrode 11 in the longitudinal direction, the plain portion 32 is provided over the entire length of the collector in the width direction. Although the plain portion 32 may be formed at an end portion side of the positive electrode 11 in the longitudinal direction, in view of the current collection, the plain portion 32 is preferably provided at a position equally apart from each of the two end portions in the longitudinal direction. In addition, the plain portion 32 may be provided to have a length from the upper end of the positive electrode 11 to a position located above the other end (lower end) thereof. The plain portion 32 is provided, for example, by intermittent application in which the positive electrode mixture slurry is not applied on a part of the positive electrode collector 30.

The negative electrode 12 includes the belt-shaped negative electrode collector 35 and at least one negative electrode active material layer 36 formed on the negative electrode collector. In this embodiment, the negative electrode active material layers 36 are formed on two surfaces of the negative electrode collector 35. For the negative electrode collector 35, for example, foil of a metal, such as copper, or a film having a surface layer on which the metal mentioned above is disposed may be used. The thickness of the negative electrode collector 35 is, for example, 5 to 30 μm.

The negative electrode active material layers 36 are preferably formed over the entire regions of the two surfaces of the negative electrode collector 35 other than plain portions 37a and 37b. The negative electrode active material layer 36 preferably contains a negative electrode active material and a binding agent. The negative electrode 12 (negative electrode plate) may be formed, for example, in such a way that after a negative electrode mixture slurry containing the negative electrode active material, the binding agent, water, and the like is applied on the two surfaces of the negative electrode collector 35, the coating films thus formed are compressed.

As the negative electrode active material, any material capable of reversibly occluding and releasing lithium ions may be used, and for example, there may be used a carbon material, such as natural graphite or artificial graphite, a metal, such as Si or Sn, forming an alloy with lithium, an alloy of the metal mentioned above, or a composite oxide. As the binding agent contained in the negative electrode active material layer 36, for example, a resin similar to that used in the case of the positive electrode 11 may be used. When the negative electrode mixture slurry is prepared using an aqueous solvent, a styrene-butadiene rubber (SBR), a CMC or its salt, a polyacrylic acid or its salt, a poly(vinyl alcohol), or the like may be used. Those materials may be used alone, or at least two thereof may be used in combination.

The negative electrode 12 has the plain portions 37a and 37b at each of which a surface of a metal forming the negative electrode collector 35 is exposed. The plain portions 37a and 37b are portions to which the negative electrode leads 20a and 20b are connected, respectively, and are portions at each of which the surface of the negative electrode collector 35 is not covered with the negative electrode active material layer 36. The plain portions 37a and 37b each have an approximately rectangular shape in front view extending long in the width direction of the negative electrode 12 and are each formed to have a width larger than that of the corresponding negative electrode lead. The plain portions 37a are preferably provided on two surfaces of the negative electrode 12 so as to be overlapped with each other in a thickness direction of the negative electrode 12 (the same may also be applied to the plain portions 37b). The negative electrode lead 20a is partially disposed on an inner surface X of the negative electrode collector of the plain portion 37a, and the remaining part of the negative electrode lead 20a extends to the lower side past the lower end of the plain portion 37a. On the inner surface X of the negative electrode collector of the plain portion 37a, the negative electrode lead 20a is disposed between an upper end side than the central portion and the lower end in the up and down direction, and at least a part of the negative electrode lead 20a is welded to the plain portion 37a.

In the example shown in FIG. 3, at the two end portions (winding-start side end portion and winding-finish side end portion) of the negative electrode 12 in the longitudinal direction, the plain portions 37a and 37b are each provided over the entire length of the collector in the width direction. For example, although the plain portion 37b may be provided at a central portion side of the negative electrode 12 in the longitudinal direction, in view of the charge collection, the plain portions are preferably separately provided at the two end portions in the longitudinal direction. In addition, the plain portions each may also be formed to have a length from the lower end of the negative electrode 12 to a position located below the upper end thereof. The plain portions are each provided, for example, by intermittent application in which the negative electrode mixture slurry is not applied on a part of the negative electrode collector 35.

As the separator 13, a porous sheet having ion permeability and an insulating property is used. As a particular example of the porous sheet, for example, a fine porous thin film, a woven cloth, or a non-woven cloth may be mentioned. As a material of the separator 13, an olefin resin, such as a polyethylene or a polypropylene, is preferable. The thickness of the separator 13 is, for example, 10 to 50 μm. The thickness of the separator 13 tends to be decreased in association with an increase in capacity and an increase in output of the battery. The separator 13 has, for example, a melting point of approximately 130° C. to 180° C.

As illustrated in FIGS. 3 to 5, the nonaqueous electrolyte secondary battery 10 includes the insulating tape 40 adhered to the winding-start side end portion of the negative electrode 12. As described above, at the plain portion 37a provided at the winding-start side end portion of the negative electrode 12, the negative electrode lead 20a is bonded to the inner surface X of the negative electrode collector facing the inside (winding core side) of the electrode assembly 14 in the radial direction. The insulating tape 40 is adhered to at least an outer surface Y of the negative electrode collector facing the outside (winding outer side) of the electrode assembly 14 in the radial direction. That is, the insulating tape 40 is adhered to, among surfaces of an overlapping portion between the negative electrode lead 20a and the negative electrode collector 35, a surface at a winding outer side. In more particular, the insulating tape 40 is preferably adhered to, among the surfaces of the overlapping portion described above, at least a region (hereinafter, referred to as “facing region” in some cases) facing the positive electrode 11 located at the winding outer side in the radial direction β.

As described above, since the negative electrode lead 20a has a thickness larger than that of the electrode plate and is provided in the vicinity of the winding core, the pressure between the electrode plates is liable to increase at the portion to which the negative electrode lead 20a is connected, and compared to the other portion, an internal short circuit caused by an electrically conductive foreign material is liable to be generated. The insulating tape 40 functions to suppress the internal short circuit as described above. In addition, even when the short circuit is generated by application of a large force, and the separator 13 is melted at the short-circuit portion, since the insulating tape 40 is provided, the expansion of the short-circuit portion is suppressed, and the increase in temperature of the battery can be suppressed.

The insulating tape 40 has, for example, an approximately rectangular shape in front view extending long in a longitudinal direction of the negative electrode lead 20a (width direction of the negative electrode collector 35). Although the shape of the insulating tape 40 is not particularly limited, the insulating tape 40 preferably has a shape corresponding to the shape of the negative electrode lead 20a.

The insulating tape 40 is preferably adhered not only to the facing region but also to the periphery thereof in consideration of winding misalignment of each electrode and the like of the electrode assembly 14. In an example shown in FIG. 5, the insulating tape 40 is adhered to extend past the end of the facing region, that is, past the position corresponding to the end of the negative electrode lead 20a (position overlapped with the collector in a thickness direction thereof). That is, the insulating tape 40 is adhered to a wide range including the facing region when the plain portion 37a is viewed in front.

The insulating tape 40 may extend past the lower end of the plain portion 37a from the surface of the negative electrode collector 35 and may be adhered to a surface of the negative electrode lead 20a which extends past the lower end of the collector, the surface facing the winding outer side. The insulating tape 40 is adhered to the outer surface Y of the negative electrode collector of the plain portion 37a, for example, after the negative electrode lead 20a is welded to the inner surface X of the negative electrode collector of the plain portion 37a.

As shown in FIG. 4, the negative electrode 12 and the separator 13 extend to the winding-start side than the positive electrode 11. In addition, the overlapping portion between the negative electrode lead 20a and the negative electrode collector 35 faces the negative electrode 12 with the separator 13 interposed therebetween. Accordingly, the internal short circuit caused by the negative electrode lead 20a can be more effectively prevented.

An embodiment illustrated in FIG. 6 is different from the above embodiment since the negative electrode lead 20a is adhered to the outer surface Y of the negative electrode collector of the plain portion 37a. In this case, the insulating tape 40 is adhered to the surface of the negative electrode lead 20a. In this case, the insulating tape 40 is also preferably adhered to at least the facing region and is more preferably adhered to a wide range including the facing region. For example, the insulating tape 40 is adhered so as to not only cover the entire surface of the negative electrode lead 20a facing the positive electrode 11 but also extend past the surface of the negative electrode lead 20a to the outer surface Y of the negative electrode collector of the plain portion 37a.

In addition, in the embodiment illustrated in FIG. 5, an additional insulating tape 40 may also be adhered to the surface of the negative electrode lead 20a facing the winding core side of the electrode assembly 14. In addition, in the embodiment illustrated in FIG. 6, an additional insulating tape 40 may also be adhered to the inner surface X of the collector of the plain portion 37a facing the winding core side. That is, the insulating tape 40 may also be adhered to the surface at a winding core side of the overlapping portion between the negative electrode lead 20a and the negative electrode collector 35.

FIG. 7 is a cross-sectional view of the insulating tape 40. As illustrated in FIG. 7, the insulating tape 40 includes the base material layer 41, the adhesive layer 42, and the inorganic particle-containing layer 43 formed between the base material layer 41 and the adhesive layer 42. The inorganic particle-containing layer 43 contains 20 percent by weight or more of inorganic particles with respect to the weight of the layer described above. When the content of the inorganic particles in the inorganic particle-containing layer 43 is less than 20 percent by weight, a sufficient heat resistance to prevent the expansion of the short-circuit portion caused by melting of the separator 13 cannot be obtained. The insulating tape 40 having the three-layer structure as described above is excellent in heat resistance and has a high piercing strength (mechanical strength). In this case, the “heat resistance” means properties in which the tape is difficult to be deteriorated and deformed by heat.

The content of the inorganic particles of the insulating tape 40 with respect to the weight of the insulating tape 40 other than the adhesive layer 42, that is, with respect to the total weight of the base material layer 41 and the inorganic particle-containing layer 43, is preferably less than 20 percent by weight, more preferably 10 percent by weight or less, and particularly preferably 5 to 10 percent by weight. As described above, when the addition amount of the inorganic particles is increased in the tape having a two-layer structure as disclosed in Patent Document 1, although the heat resistance is improved, the piercing strength is degraded. That is, the heat resistance and the piercing strength have a trade-off relationship. The insulating tape 40 is designed to decrease the content of the inorganic particles in the entire tape while the content of the inorganic particles is increased in the inorganic particle-containing layer 43. According to the insulating tape 40 as described above, an excellent heat resistance and a high piercing strength can be simultaneously obtained.

The thickness of the insulating tape 40 is, for example, 20 to 70 μm and preferably 25 to 60 μm. The thickness of each layer of the insulating tape 40 can be measured by cross-sectional observation using a scanning electron microscope (SEM). The insulating tape 40 may have a layered structure including at least four layers. For example, the base material layer 41 is not limited to a monolayer structure and may be a laminate film formed of at least two layers equivalent to or different from each other.

The base material layer 41 preferably contains no inorganic particles and is preferably formed substantially only from an organic material. The rate of the organic material to the constituent materials of the base material layer 41 may be, for example, 90 percent by weight or more, preferably 95 percent by weight or more, or approximately 100 percent by weight. The primary component of the organic material is preferably a resin excellent in insulating property, electrolyte liquid resistance, heat resistance, piercing strength, and the like. The thickness of the base material layer 41 is, for example, 10 to 45 μm and preferably 15 to 35 μm. The thickness of the base material layer 41 is preferably larger than that of each of the adhesive layer 42 and the inorganic particle-containing layer 43 and is 50% or more of the thickness of the insulating tape 40.

As a preferable resin forming the base material layer 41, for example, there may be mentioned an ester-based resin, such as a poly(ethylene terephthalate) (PET), a polypropylene (PP), a polyimide (PI), a poly(phenylene sulfide), or a polyimide. Those resins may be used alone, or at least two types thereof may be used in combination. Among those resins mentioned above, a polyimide having a high piercing strength is particularly preferable. For the base material layer 41, for example, a resin film containing a polyimide as a primary component may be used.

The adhesive layer 42 is a layer which imparts to the insulating tape 40, an adhesion property to the positive electrode lead 19. The adhesive layer 42 is formed, for example, by applying an adhesive on one surface of the base material layer 41 on which the inorganic particle-containing layer 43 is formed. As is the case of the base material layer 41, the adhesive layer 42 is preferably formed using an adhesive (resin) excellent in insulating property, electrolyte liquid resistance, and the like. Although an adhesive forming the adhesive layer 42 may be either a hot-melt type which exhibits an adhesion property by heating or a thermosetting type which is cured by heating, in view of the productivity and the like, an adhesive having an adhesion property at room temperature is preferable. The adhesive layer 42 is formed, for example, using an acrylic-based adhesive or a synthetic rubber-based adhesive. The thickness of the adhesive layer 42 is, for example, 5 to 30 μm.

As described above, the inorganic particle-containing layer 43 is a layer containing 20 percent by weight or more of inorganic particles and is a layer mainly imparting a heat resistance to the insulating tape 40. The inorganic particle-containing layer 43 preferably has a layer structure in which the inorganic particles are dispersed in a resin matrix which forms the layer. The inorganic particle-containing layer 43 is formed, for example, by applying a resin solution containing the inorganic particles to one surface of the base material layer 41. The thickness of the inorganic particle-containing layer 43 is, for example, 0.5 to 10 μm and preferably 1 to 5 μm.

The content of the inorganic particles with respect to the weight of the inorganic particle-containing layer 43 is preferably 25 to 80 percent by weight, more preferably 30 to 80 percent by weight, and particularly preferably 35 to 80 percent by weight. In the insulating tape 40, since the base material layer 41 is provided, and in addition, the inorganic particle-containing layer 43 is provided between the base material layer 41 and the adhesive layer 42, even when the addition amount of the inorganic particles of the inorganic particle-containing layer 43 is increased, a preferable piercing strength can be secured. However, when the addition amount of the inorganic particles is excessively increased, the film strength of the inorganic particle-containing layer 43 is decreased, and the piercing strength may be decreased in some cases; hence, the upper limit of the content of the inorganic particles of the inorganic particle-containing layer 43 is preferably 80 percent by weight. In addition, the upper limit described above is further preferably 50 percent by weight.

As is the case of the base material layer 41, a resin forming the inorganic particle-containing layer 43 is preferably excellent not only in insulating property, electrolyte liquid resistance, and the like but also in adhesion property to the inorganic particles and the base material layer 41. As a preferable resin, for example, there may be mentioned an acrylic-based resin, a urethane-based resin, or an elastomer thereof. Those resins may be used alone, or at least two types thereof may be used in combination.

The inorganic particles forming the inorganic particle-containing layer 43 are preferably particles having an insulating property and a small particle diameter. The average particle diameter of the inorganic particles is, for example, 50 to 500 nm and preferably 50 to 200 nm. As preferable inorganic particles, for example, there may be mentioned titania (titanium oxide), alumina (aluminum oxide), silica (silicon oxide), or zirconia (zirconium oxide).

Those types of inorganic particles may be used alone, or at least two types thereof may be used in combination. Among those inorganic particles, silica is particularly preferable.

### EXAMPLES

Hereinafter, although the present disclosure will be further described with reference to Examples, the present disclosure is not limited thereto.

### Example 1

[Formation of Positive Electrode]

After 100 parts by weight of a lithium transition metal oxide (average particle diameter: 12 μm, layered rock salt structure (hexagonal crystal, space group: R3-m) represented by LiNi_{0.88}Co_{0.09}Al_{0.03}O₂ as a positive electrode active material, 1 part by weight of acetylene black, and 1 part by weight of poly(vinylidene fluoride) were mixed together, an appropriate amount of N-methyl-2-pyrrolidone (NMP) was further added thereto, so that a positive electrode mixture slurry was prepared. Next, the positive electrode mixture slurry was applied on two surfaces of a positive electrode collector formed of aluminum foil, and the coating films thus formed were dried. The collector on which the coating films were formed was compressed using a roller machine and then cut into a predetermined electrode size, so that a positive electrode plate in which the positive electrode active material layers were formed on the two surfaces of the positive electrode collector was formed. A plain portion was provided at a central portion of the positive electrode plate in a longitudinal direction, and an aluminum-made positive electrode lead was ultrasonic-welded to the above plain portion, so that a positive electrode was formed.

[Formation of Negative Electrode]

After 100 parts by weight of a graphite powder (average particle diameter: 20 m), 1 part by weight of a styrene-butadiene rubber (SBR), and 1 part by weight of a carboxymethyl cellulose were mixed together, an appropriate amount of water was further added thereto, so that a negative electrode mixture slurry was prepared. Next, the negative electrode mixture slurry was applied on two surfaces of a negative electrode collector formed of copper foil, and the coating films thus formed were dried. The collector on which the coating films were formed was compressed using a roller machine and then cut into a predetermined electrode size, so that a negative electrode plate in which the negative electrode active material layers were formed on the two surfaces of the negative electrode collector was formed.

Negative electrode leads were ultrasonic-welded to respective plain portions provided at a winding-start side end portion and a winding-finish side end portion of the negative electrode plate, and an insulating tape having a three-layer structure formed of a base material layer/an inorganic particle-containing layer/an adhesive layer was adhered to an outer surface of the collector of the plain portion at the winding-start side end portion. In an electrode assembly, among ranges overlapped with the negative electrode lead on the outer surface of the collector in a radial direction of the electrode assembly, the insulating tape was adhered to a range overlapped with the positive electrode located at a winding outer side in the radial direction and the periphery thereof.

A particular layered structure of the above insulating tape is as described below.

As the base material layer, a resin film (thickness: 25 μm) containing a polyimide as a primary component was used. The inorganic particle-containing layer had a layer structure in which silica particles in an amount of 25 percent by weight were dispersed in an acrylic resin. The thickness of the inorganic particle-containing layer was 1 μm. The adhesive layer was formed of an adhesive (primary component: acrylic-based resin) having an adhesion property at room temperature. The content of the silica particles with respect to the total weight of the base material layer and the inorganic particle-containing layer was 0.8 percent by weight.

[Preparation of Nonaqueous Electrolyte]

Ethylene carbonate (EC), ethyl methyl carbonate (EMC), and dimethyl carbonate (DMC) were mixed together at a volume ratio of 3:3:4. In this mixed solvent, LiPF₆ was dissolved at a concentration of 1 mol/L, so that a nonaqueous electrolyte was prepared.

[Formation of Battery]

The positive electrode and the negative electrode were spirally wound with separators interposed therebetween, the separators each being formed of a polyethylene-made porous film having one surface on which a polyamide layer containing alumina particles was formed, so that a wound electrode assembly in which a space was formed at a winding core was formed. The negative electrode was disposed so that the negative electrode lead welded to the winding-start side end portion faced a winding core side. In the electrode assembly thus obtained, among the ranges overlapped with the negative electrode lead on the outer surface of the collector in the radial direction, the insulating tape was adhered to at least the range overlapped with the positive electrode located at the winding outer side in the radial direction. After the electrode assembly was received in a cylindrical metal-made case main body (outer diameter: 18 mm, height: 65 mm) having a bottom plate, an upper end portion of the positive electrode lead was welded to a filter of a sealing body, and lower end portions of the negative electrode leads were welded to a bottom inner surface of the case main body. In addition, the nonaqueous electrolyte liquid was charged into the case main body, and an opening portion of the case main body was sealed by the sealing body, so that a 18650 type cylindrical battery was formed.

### Example 2

Except for that an insulating tape was used in which instead of the inorganic particle-containing layer of Example 1, an inorganic particle-containing layer containing 35 percent by weight of silica particles and having a thickness of 5 μm was formed, a negative electrode and a cylindrical battery were formed in a manner similar to that of Example 1. The content of the inorganic particles with respect to the total weight of the base material layer and the inorganic particle-containing layer was 5 percent by weight.

### Example 3

Except for that an insulating tape was used in which instead of the inorganic particle-containing layer of Example 1, an inorganic particle-containing layer containing 70 percent by weight of silica particles and having a thickness of 5 μm was formed, a negative electrode and a cylindrical battery were formed in a manner similar to that of Example 1. The content of the inorganic particles with respect to the total weight of the base material layer and the inorganic particle-containing layer was 10 percent by weight.

### Example 4

Except for that an insulating tape was used in which instead of the inorganic particle-containing layer of Example 1, an inorganic particle-containing layer containing 35 percent by weight of silica particles and having a thickness of 1 μm was formed, a negative electrode and a cylindrical battery were formed in a manner similar to that of Example 1. The content of the inorganic particles with respect to the total weight of the base material layer and the inorganic particle-containing layer was 1 percent by weight.

### Comparative Example 1

Except for that an insulating tape including no inorganic particle-containing layer (the remaining layer structure was the same as that of Example 1) was used, a negative electrode and a cylindrical battery were formed in a manner similar to that of Example 1.

### Comparative Example 2

Except for that an insulating tape was used in which instead of the inorganic particle-containing layer of Example 1, an inorganic particle-containing layer containing 10 percent by weight of silica particles and having a thickness of 5 μm was formed, a negative electrode and a cylindrical battery were formed in a manner similar to that of Example 1. The content of the inorganic particles with respect to the total weight of the base material layer and the inorganic particle-containing layer was 1.5 percent by weight.

### Comparative Example 3

Except for that an insulating tape having a two-layer structure which included an inorganic particle-containing layer, an adhesive layer, and no base material layer was used, a negative electrode and a cylindrical battery were formed in a manner similar to that of Example 1. The content of silica particles in the inorganic particle-containing layer was set to 50 percent by weight, and the thickness of the inorganic particle-containing layer was set to 25 μm.

A piercing test was performed on each of the insulating tapes of the above Examples and Comparative Examples by the following method. In addition, a foreign material short-circuit test was performed on each battery by the following method.

[Piercing Test]

The surface of each of the above insulating tapes was pierced by a needle, and a pressing force (N) at which penetration was confirmed by visual inspection was measured. The pressing force is shown in Table 1 as a piercing strength. A higher pressing force indicates a higher strength of the tape.

[Foreign Material Short-Circuit Test]

After an electrically conductive foreign material was placed between the outer surface of the collector of the negative electrode covered with the insulating tape and the positive electrode located at the winding outer side, in accordance with JIS C 8714, a side surface temperature of the battery was measured using a thermocouple when the short circuit was forcibly performed. The measurement results are shown in Table 1. When the above temperature is lower, it indicates that the expansion of the short-circuit portion is more unlikely to occur.

TABLE 1

| | EXAM- | EXAM- | EXAM- | EXAM- | COMPARATIVE | COMPARATIVE | COMPARATIVE |
|---|---|---|---|---|---|---|---|
| | PLE 1 | PLE 2 | PLE 3 | PLE 4 | EXAMPLE 1 | EXAMPLE 2 | EXAMPLE 3 |
| THICKNESS OF BASE MATERIAL LAYER (μm) m | 25 | 255 | 25 | 25 | 25 | 25 | — |
| THICKNESS OF INORGANIC PARTICLE- | 1 | 5 | 5 | 1 | — | 5 | 25 |
| CONTAINING LAYER (μm) | | | | | | | |
| CONTENT OF INORGANIC PARTICLES*¹ | 25 | 35 | 70 | 35 | 0 | 10 | 50 |
| CONTENT OF INORGANIC PARTICLES*² | 0.8 | 5 | 10 | 1 | 0 | 15 | 50 |
| PIERCING STRENGTH (N) | 110 | 113 | 110 | 111 | 10.8 | 11.0 | 7.3 |
| BATTERY TEMPERATURE (° C.) | 86 | 48 | 35 | 55 | >100 | >100 | 74 |

*¹Content (percent by weight) of the inorganic particles with respect to the weight of the inorganic particle-containing layer.
*²Content (percent by weight) of the inorganic particles with respect to the weight of the insulating tape other than the adhesive layer.

As shown in Table 1, since the insulating tape of each Example has a high piercing strength, according to the battery of each Example using the insulating tape described above, the internal short circuit to be generated in the vicinity of the winding core by the influence of the negative electrode lead can be highly suppressed. On the other hand, since the insulating tape of Comparative Example 3 has a low piercing strength although having a high heat resistance, according to the battery of Comparative Example 3 using the insulating tape described above, the internal short circuit described above cannot be sufficiently overcome.

Furthermore, compared to the batteries of Comparative Examples 1 and 2, the batteries of the above Examples all have a low battery temperature in the foreign material short-circuit test, that is, has a low battery temperature when the short circuit is forcibly performed. In the foreign material short-circuit test, although the separator of every battery is melted by heat generation at the short-circuit portion, in the battery of each Example, since the contact between the positive electrode lead and the negative electrode is prevented by the insulating tape having a high heat resistance, the expansion of the short-circuit portion is suppressed. Since the insulating tape of Example 3 is particularly excellent in heat resistance among those of Examples 2 to 4, in the battery using the tape described above, the expansion of the short-circuit portion is highly suppressed. On the other hand, in the batteries of Comparative Examples 1 and 2, since the heat resistance of the insulating tape is not sufficient, the contact between the positive electrode lead and the negative electrode cannot be prevented, and hence, it is believed that the battery temperature is remarkably increased.

That is, only in the case in which the insulating tape including at least three layers, that is, the base material layer/the inorganic particle-containing layer containing 20 percent by weight or more of inorganic particles/the adhesive layer, is used, the internal short circuit to be generated in the vicinity of the winding core by the influence of the negative electrode lead can be highly suppressed, and even when the internal short circuit is generated, the increase in battery temperature can be suppressed.

### REFERENCE SIGNS LIST

10 nonaqueous electrolyte secondary battery, 11 positive electrode, 12 negative electrode, 13 separator, 14 electrode assembly, 15 case main body, 16 sealing body, 17, 18 insulating plate, 19 positive electrode lead, 20a, 20b negative electrode lead, 21 protruding portion, 22 filter, 23 lower valve body, 24 insulating member, 25 upper valve body, 26 cap, 27 gasket, 28 space, 30 positive electrode collector, 31 positive electrode active material layer, 32 plain portion, 35 negative electrode collector, 36 negative electrode active material layer, 37a, 37b plain portion, 40 insulating tape, 41 base material layer, 42 adhesive layer, 43 inorganic particle-containing layer, X inner surface of negative electrode collector, Y outer surface of negative electrode collector

1. A nonaqueous electrolyte secondary battery comprising:
a winding type electrode body in which a positive electrode and a negative electrode are wound with at least one separator interposed therebetween,
wherein the negative electrode includes a belt-shaped negative electrode collector and a negative electrode lead bonded to a winding-start side end portion of the negative electrode collector,
an insulating tape is adhered to, among surfaces of an overlapping portion of the negative electrode lead and the negative electrode collector, at least a surface at an outer side in a radial direction of the electrode body,
the insulating tape includes a base material layer, an adhesive layer, and an inorganic particle-containing layer formed between the base material layer and the adhesive layer, and
the inorganic particle-containing layer contains 20 percent by weight or more of inorganic particles with respect to the weight of the inorganic particle-containing layer.

2. The nonaqueous electrolyte secondary battery according to claim 1, wherein the negative electrode lead is bonded to an outer surface of the negative electrode collector.

3. The nonaqueous electrolyte secondary battery according to claim 1, wherein the negative electrode lead is bonded to an inner surface of the negative electrode collector.

4. The nonaqueous electrolyte secondary battery according to claim 1, wherein the overlapping portion faces a part of the negative electrode with the separator interposed therebetween.

5. The nonaqueous electrolyte secondary battery according to claim 1, wherein the content of the inorganic particles is 25 to 80 percent by weight with respect to the weight of the inorganic particle-containing layer.

6. The nonaqueous electrolyte secondary battery according to claim 1, wherein the thickness of the inorganic particle-containing layer is 1 to 5 μm.

7. The nonaqueous electrolyte secondary battery according to claim 1, wherein the content of the inorganic particles is less than 20 percent by weight with respect to the weight of the insulating tape other than the adhesive layer.

8. The nonaqueous electrolyte secondary battery according to claim 1, wherein the base material layer is formed of a polyimide as a primary component.
